(19) United States
(12) Patent Application Publication
(10) Pub. No.: US 2026/0287505 A1
(43) Pub. Date: Sep. 24, 2026

(54) LASER-BASED REMOTE GAS SENSING VIA OPTICAL FIBER BEAM DELIVERY

(71) Applicant: California Institute of Technology, Pasadena, CA (US)

(72) Inventors: Axel SCHERER, Barnard, VT (US); Changsoon CHOI, Pasadena, CA (US); Taeyoon JEON, Pasadena, CA (US)

(21) Appl. No.: 19/571,694

(22) Filed: Mar. 19, 2026

Related U.S. Application Data
(60) Provisional application No. 63/774,844, filed on Mar. 20, 2025.

(51) Int. Cl. G01N 21/39; G01N 21/01

(52) U.S. Cl. CPC G01N 21/39; G01N 21/01; G01N 2021/399

(57) ABSTRACT

A gas/gas-leak detection system includes a narrow-wavelength tunable laser, an optical delivery system, a plurality of gas-monitoring cells, a detector, and signal-processing electronics. The optical delivery system utilizes optical fiber to deliver a beam from the laser to each of the gas-monitoring cells, one cell at a time. The laser is tuned so that its optical frequency is near to a frequency of an absorption line of a gas of interest. The beam of light is passed through each cell, and returned through the optical delivery system to a photodetector. Assuming that the gas of interest is present in the cell, the intensity of the beam is affected by its passage through the cell. The intensity of a return beam, as detected by the photodetector, correlates to gas concentration.

### STATEMENT OF RELATED CASES

This disclosure pertains to gas/gas-leak detection, and more particularly, to gas detection employing narrow-bandwidth tunable lasers.

### BACKGROUND

Tunable Diode Laser Absorption Spectroscopy (TDLAS) measures gas concentration by detecting intensity drops when target gas molecules are present in the optical path between a narrow-linewidth tunable laser and a detector. More particularly, gas molecules, such as methane, carbon dioxide, water, ammonia, etc., absorb light at very specific wavelengths corresponding to their rotational-vibrational transitions. The TDLAS technique detects and quantifies a gas species based on the absorption of laser light at those specific wavelengths. The amount of absorbed light enables direct calculation of gas concentration.

Gas-detection systems based on TDLAS techniques have been used in the oil and gas industry to detect gas-leaks. There are, however, drawbacks to the use of such systems, as implemented in the past.

### SUMMARY

Embodiments of the invention provide systems and methods for gas/gas-leak detection based on TDLAS techniques, but which avoid certain limitations of existing TDLAS-based leak-detection systems.

In accordance with the illustrative embodiment, a gas/gas-leak detection system includes a narrow-wavelength tunable laser, an optical delivery system, a plurality of gas-monitoring cells, a detector, and signal-processing electronics. The optical delivery system utilizes optical fiber to deliver light from the laser to each of the gas-monitoring cells, one cell at a time. In addition to other benefits, this system enables gas concentrations to be measured over long distances and without requiring line-of-sight between the laser source and the monitored location.

Each gas-monitoring cell includes a collimation lens and a retroreflector, and is capable of receiving gas from the ambient environment. In operation, an optical beam is delivered by the optical delivery system to each of a plurality of gas-monitoring cells, one-by-one. Upon entering a cell, the beam is collimated by the collimation lens and is directed toward the retroreflector, passing through whatever gas has entered the cell. The beam is then returned to the collimation lens by the retroreflector, and then re-launched into the optical delivery system. The beam propagates through the optical delivery system to the detector. The return signal from each gas-monitoring cell is analyzed via signal processing electronics.

The system’s laser is tuned to the specific of a gas of interest. More particularly, the narrow-wavelength tunable laser is tuned so that its optical frequency is near to the frequency of the absorption line of the gas of interest. The laser is modulated to create a controlled scan across the absorption line, which enables extraction of absorption information with high sensitivity. The beam enters and traverses the gas-monitoring cell toward the retroreflector. To the extent a gas of interest is present in the gas-monitoring cell, the gas will absorb some energy from the beam, thereby affecting the intensity of the beam (i.e., reducing its intensity relative to that of the beam entering the cell). Because absorption is nonlinear with respect to wavelength near a spectral line, the detected signal contains harmonics of the modulation frequency. Of particular interest is the second harmonic (2f), which is processed to determine the presence and concentration of the gas at each gas-monitoring cell.

By positioning a plurality of gas-monitoring cells throughout an area to be monitored, the system can identify the presence and concentration of gas —and hence gas leaks— throughout the monitored area. Knowing the location of each gas-monitoring cell enables the system to localize the leak. Via the use of fiber optics and, in some embodiments, optical switches, a single laser and detector can support a system that includes many gas-monitoring cells.

In some embodiments, the invention provides a system for identifying the presence of a gas and its concentration, wherein the system includes: a narrow-wavelength tunable laser for producing a beam of light, wherein the laser is tuned so that an optical frequency thereof is near to a frequency of an absorption line of a gas of interest, and is modulated to create a controlled scan across the frequency of the absorption line; a plurality of gas-monitoring cells that are gas permeable, wherein the gas-monitoring cells are situated at various locations throughout the monitored area; an optical delivery system comprising at least one optical fiber, wherein the optical delivery system guides the beam of light to each of the gas-monitoring cells, one gas-monitoring cell at a time, and wherein the beam of light is guided by the optical fiber for at least a portion of an optical path from the laser to each gas-monitoring cell; a photodetector; and signal-processing electronics.

Within each gas-monitoring cell, the beam of light received thereby propagates therethrough in free space, and then re-enters the optical delivery system and is directed thereby to the photodetector. The photodetector generates signals that are indicative, respectively, of an intensity of the beam of light delivered from each gas-monitoring cell. And the signal-processing electronics determines, for each gas-monitoring cell, if the gas of interest is present and, if so, a concentration thereof, based on the intensity of the respective beams of light.

In some embodiments, the invention provides a method for identifying the presence of a gas and its concentration, wherein the method includes:
generating a first beam of light from a narrow-wavelength tunable laser, wherein the first beam of light:
   a. has an optical frequency near to a frequency of an absorption line of a gas of interest, and
   b. is modulated to create a controlled scan across the frequency of the absorption line;
receiving, at a local distribution system, the first beam of light, wherein the local distribution system directs the first beam of light to a fiber relay system comprising a plurality of optical fibers, wherein the optical fibers are optically coupled to a plurality of gas-monitoring cells that are situated at various locations throughout the monitored area;
receiving the first beam of light from the optical fibers at respective ones of the gas-monitoring cells, one gas-monitoring cell at a time;
directing the first beam of light through the respective ones of the gas-monitoring cells;
launching, one at a time, into the fiber relay system, respective beams of light resulting from passage of the first beam of light through the respective gas-monitoring cells;
receiving, at the local distribution system, the respective beams of light from the fiber relay system and directing the respective beams of light, one at a time, to a photodetector;
generating, at the photodetector, signals that are indicative of an intensity of the respective beams of light; and
determining, for each of the gas-monitoring cells, if the gas of interest is present and, if so, a concentration thereof, based on the signals.

Additional embodiments in accordance with the present teachings are provided in the drawings and detailed description that follows.

### BRIEF DESCRIPTION OF THE DRAWINGS

FIG. 1 depicts a flow diagram of conventional TDLAS processing for gas detection.

FIG. 2 depicts a gas/gas-leak detection system, including an optical delivery system and a plurality of gas-monitoring cells, in accordance with an illustrative embodiment of the invention.

FIG. 3 depicts an embodiment of a gas-monitoring cell for use in the system of FIG. 2.

FIG. 4A depicts a first embodiment of the local distribution system for use in the system of FIG. 2.

FIG. 4B depicts a second embodiment of the local distribution system for use in the system of FIG. 2.

FIG. 5 depicts an embodiment of a gas/gas-leak detection system in accordance with the present teachings.

### DETAILED DESCRIPTION

The following disclosure merely illustrates the principles of the invention. It will thus be appreciated that in light of the disclosure, those skilled in the art will be able to devise various arrangements which, although not explicitly described or shown herein, embody the principles of the invention and are included within its spirit and scope. Furthermore, all examples and conditional language recited herein are principally intended for pedagogical purposes to aid the reader in understanding the principles of the invention and the concepts contributed by the inventor(s) to furthering the art, and are to be construed as being without limitation to specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as those developed in the future; that is, any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes that may be substantially represented in computer readable medium and so executed by a computer or processor, whether or not such computer or processor is explicitly shown.

Some embodiments in accordance with the present teachings provide improved gas leak-detection systems and methods based on Tunable Diode Laser Absorption Spectroscopy (TDLAS) techniques. In conjunction with the novel use of fiber optics, systems in accordance with the present teaching result in a number of advantages in comparison to the prior art. For context, a discussion of conventional TDLAS technology is presented before disclosing the improved systems and methods in accordance with the present teachings.

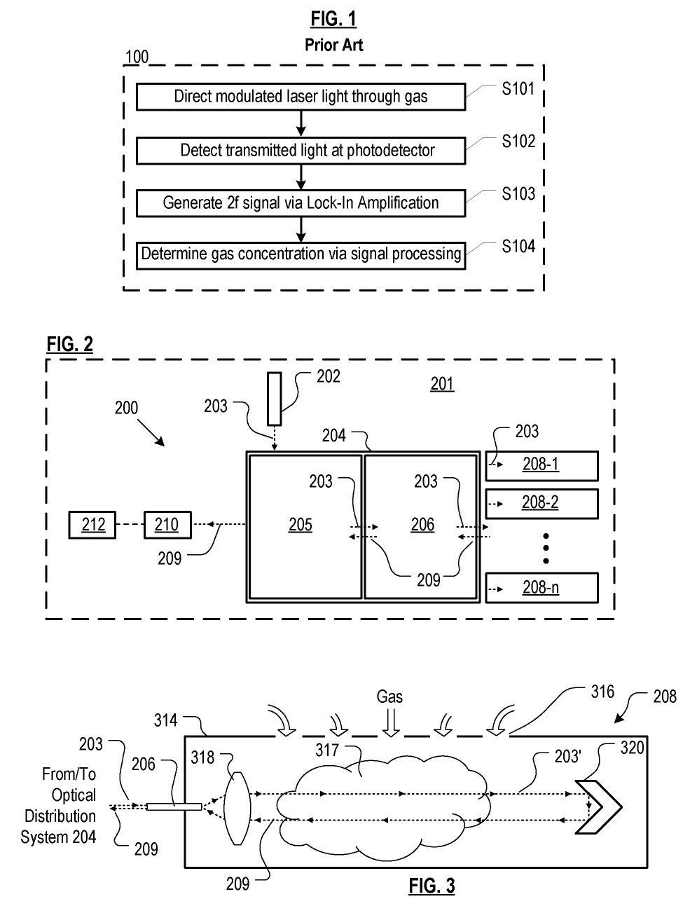

Basic TDLAS operation . FIG. 1 depicts flow diagram 100 illustrating conventional TDLAS processing, such as may be used in conjunction with embodiments of the present invention.

In step S101, a narrow-linewidth tunable diode laser is tuned so that its optical frequency is near to the frequency of the absorption line of a gas of interest. The laser is modulated to create a controlled scan across the absorption line, which enables extraction of absorption information with high sensitivity. Two simultaneous modulations are typically used: a slow wavelength scan and a high-frequency sinusoidal modulation. The improves the sensitivity and noise rejection.

If the gas of interest is present in a region through which the laser light passes, photons from the laser light are absorbed by the gas (i.e., when the frequency of the modulated laser light matches a specific molecular transition of the gas). The greater the gas concentration, the greater the absorption of photons (other parameters being equal). Because absorption of photons is nonlinear in wavelength, harmonics of the modulation frequency are generated. It is notable that the absorption of such modulated laser light converts wavelength modulation into intensity modulation.

At step S102, the laser light that has passed through the gas is detected at a photodetector, which converts the optical power of the received laser-light signal to current. A transimpedance amplifier converts the current to voltage. The detected signal contains a DC component, the fundamental modulation frequency (1f), harmonics (2f, 3f, etc.), and noise.

At step S103, the signal is sent to a lock-in amplifier. The lock-in amplifier typically extracts the 2f signal (the second harmonic). Although both the 1f and 2f signals contain absorption information, 2f-signal detection is preferred for sensitivity, stability, and baseline robustness. Low-pass filtering extracts the amplitude of the 2f signal.

At step S104, conventional signal processing determines the gas concentration from the extracted amplitude. This is typically performed by a model-based fitting (e.g., performing a non-linear least-squares fit against a modeled Voigt line shape, etc.).

Having presented a brief overview of basic TDLAS processing, embodiments in accordance with the present teachings are now presented.

FIG. 2 depicts gas/gas-leak detection system 200 in accordance with the illustrative embodiment. In the illustrative embodiment, system 200 is deployed in gas-processing facility 201. System 200 includes laser 202, optical delivery system 204, a plurality of gas-monitoring cells 208 (i.e., 208-1, 208-2 … 208- n ), detector 210, and signal-processing electronics 212.

Laser 202 may be embodied as any of a variety of lasers that have a narrow linewidth and are tunable over a wavelength range of interest, which is the wavelength range of the absorption spectrum of one or more gases of interest. In the illustrative embodiment, the laser is a Distributed Feedback (DFB) laser having a narrow linewidth, which can be tuned to a specific frequency that is near to the (primary) absorption line of a gas of interest, such as methane, and that can be modulated to create a controlled scan across the frequency of the absorption line. Other types of lasers that are suitable for use in conjunction with embodiments of the invention include, without limitation, a Distributed Bragg Reflector (DBR) lasers, External Cavity Diode (ECD) lasers, and certain fiber lasers. Relative to other lasers, DFB and DBR lasers are relatively lower cost and complexity, and are therefore preferred for use.

In the illustrative embodiment, optical delivery system 204 is responsible for directing beam 203 from laser 202 to gas-monitoring cells 208, and directing beam 209 from gas-monitoring cells 208 to detector 210. Optical delivery system 204 includes local distribution system 205 and fiber relay system 206.

Local distribution system 205 includes optics suitable for receiving beam 203 from laser 202 and routing the beam towards fiber relay system 206, and for receiving a return beam/signal 209 from fiber relay system 206 and routing it to detector 210. Fiber relay system includes one, and typically more than one, optical fibers. Local distribution system 205 is operable to selectively direct beam 203 to each optical fiber of fiber relay system 206. The optical fibers optically couple to gas monitoring cells 208. Optical fibers 206 may be single-mode fiber. It is within the capabilities of those skilled in the art to select optical fiber suitable for use in conjunction with embodiments of the invention.

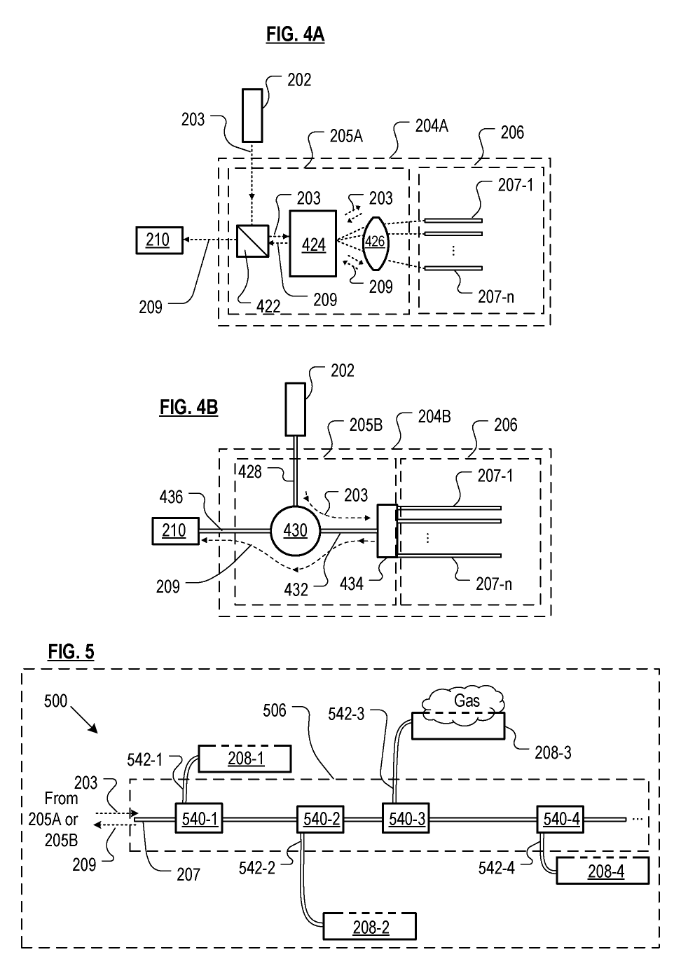

Local-distribution system 205 and fiber-relay system 206 are described in further detail below in conjunction with FIGS. 4A and 4B.

Detector 210 is a photodetector, which converts the power of the received optical signal to a current. Typically, a transimpedance amplifier is used to convert the current to a voltage for further processing.

Signal-processing electronics 212 includes electronics suitable for processing signals generated by photodetector 210. Such electronics include, among any other electronics, a lock-in amplifier, low-pass filters, a processor running software that is capable of controlling optical switches and software that is capable of computing the concentration of the detected gas and estimating the location of a leak, and processor-accessible memory.

In the embodiment depicted in FIG. 2, laser 202, local distribution system 205, detector 210, and signal-processing electronics 212 are co-located, whereas, by virtue of fiber relay system 206, the plural gas-monitoring cells 208 are situated at various locations throughout a region being monitored, such as gas-processing facility 201. In some other embodiments, signal-processing electronics 212 is located remotely from the laser/local distribution system/detector. Typical of such other embodimentsare those in which the system is installed in a very large facility, such that it is desirable to have multiple instances of lasers/local distribution systems/detectors located throughout.

In FIG. 2, gas-monitoring cells 208 are depicted as being arranged in a regular array. This is merely for clarity of illustration; in a typical installation, the prevailing placement considerations will result in gas-monitoring cells 208 being sited at a variety of locations that do not result in a regular arrangement (arrayed or otherwise). For example, as a basic consideration, gas-monitoring cells 208 may be positioned near to locations at which leaks most commonly occur. In a facility that processes gas (e.g., natural gas processing facility, a refinery, a hydrogen production facility, etc.), such locations include, without limitation, flanged connections, valves, fittings, pressure-relief devices, pumps and compressors, and welded joints. And to the extent that conditions such as vibration, thermal cycling, high pressure, or the presence of corrosive gas are present at a location, that increases the likelihood of leaks.

FIG. 3 depicts an illustrative embodiment of gas-monitoring cell 208. In the illustrative embodiment, cell 208 includes collimation lens 318 and retroflector 320, which are contained within enclosure 314 and disposed at opposite ends thereof. Although depicted as a spherical lens, collimation lens 318 is preferably aspheric. Retroreflectors 208 return incoming light back toward its source, largely independent of the angle of incidence of the light. Retroflectors may be of any suitable type, including, without limitation, corner-cube retroreflectors, cat’s-eye retroflectors, ball-lens retroreflectors, or micro-prismatic retroreflectors. Enclosure 314 is fabricated from a composite material or metal, and is physically adapted to enable gas to enter. Thus, enclosure 314 may be, for example, five-sided, include discrete openings 316, and/or incorporate a gas-permeable membrane, etc.

Beam 203 from laser 202 is delivered, via optical fibers 207 (of fiber relay system 206), to (each) gas-monitoring cell 208 (one cell at a time) by virtue of the operation of local distribution system 205. In gas-monitoring cell 208, beam 203 is collimated by collimation lens 318 and is directed towards retroreflector 320, and then returned to collimation lens 318. After passing back through collimation lens 318, the beam is launched into optical fiber 207 and propagates therethrough to local distribution system 205 and finally to detector 210 (see FIG. 2).

In FIG. 3, gas 317 is present in cell 208, having entered the cell (e.g., through openings 316) from the ambient environment. As a consequence, beam 203 passes through gas 317 on its way to retroreflector 320. Assuming the laser is appropriately tuned for gas 317 as previously described, some photons from beam 203 are absorbed by the gas. This alters beam 203 (i.e., decreases its intensity) resulting in beam 203’. Retroreflector 320 directs beam 203’ back towards collimation lens 318, such that the beam makes a second pass through gas 317. Some photons are thus absorbed from beam 203’, altering it, resulting in beam/signal 209.

In some embodiments, additional mirrors/reflectors may be used within enclosure 314 to extend the path of the optical beam. This increases the interaction between the beam and the gas molecules, thereby increasing the sensitivity of system 200. In some embodiments, a fan or other device may be used to draw gas into enclosure 314 from the ambient environment, thereby improving measurement efficiency and detection speed.

Performing steps S102 through S104 of method 100 enables system 200 to detect the presence of a gas of interest and its concentration at that particular gas-monitoring cell 208. Knowing the location, within the monitored area, of the gas-monitoring cell 208 at which gas is detected enables the system to determine the location of a gas leak.

The use of fibers optics, in systems in accordance with the present teachings, provides certain advantages relative to prior-art gas detection systems. In particular, a key limitation of many prior-art TDLAS-based systems is the requirement for a clear line of sight between the tunable laser source and the measurement location. Because a laser beam propagates in a straight line, it is challenging to measure gas concentrations in areas that are obstructed, far away from the laser source, or otherwise out of sight. To overcome this limitation, some prior-art systems integrate a TDLAS detection system with an unmanned aerial vehicle (UAV), such as a drone. But this approach has its drawbacks. Drones cannot provide continuous, real-time monitoring of large areas, and their measurements are typically limited to a top-down perspective. This makes it difficult to monitor complex facilities with multiple layers of structures, where gas leaks may occur at various heights and in obstructed locations. In contrast, embodiments of the invention utilize optical fiber to direct laser light to a measurement location, thereby avoiding the line-of-sight problem as well as limitations associated with aerial drone-based monitoring.

Moreover, whereas some prior-art laser-based gas-detection systems (particularly drone-based systems) rely on various relatively low-reflectivity surfaces to return the optical signal to the laser/detector, embodiments of the invention use retroflectors, which are highly reflective. Consequently, the significant scattering and absorption losses suffered by many prior-art systems are largely avoided in embodiments of the invention. This provides embodiments of the invention with significantly higher sensitivity than prior-art systems.

It is notable that embodiments of a gas/gas-leak monitoring system, such as system 200, may be used for gas detection in indoor environments, such as measuring the concentration of, for example, toxic gases in each apartment in an apartment building, or each room in an apartment/house.

FIGS. 4A and 4B depict two embodiments of local distribution system 204. As previously described, local distribution system 204 directs beam 203 from laser 202 to fiber relay system 206, and routes a return beam/signal 209 from fiber relay system 206 to detector 210.

FIG. 4A depicts local distribution system 205A, which is a free-space optics implementation of local distribution system 205 of FIG. 2. Local distribution system 205A includes beam splitter 422, beam steerer 424, and collimation lens 426.

Beam splitter 422 directs substantially all of beam 203 it receives from laser 202 toward beam scanner 424, and directs substantially all of beam 209 light it receives from fiber relay system 206 to detector 210.

Beam scanner 424 is capable of steering light in multiple directions in a controlled manner; in this application, it steers laser beam 203 to (ultimately) plural optical fibers 207, one fiber at a time. Before entering the optical fiber, beam 203 is passed through collimation lens 426.

In some embodiments, beam scanner 424 is a galvanometer (galvo) scanner, in which a small mirror is rotated rapidly and with high precision to direct outgoing optical beam 203 to (ultimately) each optical fiber 207. In system 200, beam scanner 424 also receives returning optical signal 209. Other types of beam scanners, such as polygon scanners or MEMS mirror scanners may suitably be used.

In some embodiments, such as the embodiment depicted in FIG. 2, each optical fiber 207 couples directly a specific gas-monitoring cell 208. Thus, beam 203 received by a particular optical fiber 207 is directly delivered to an optically coupled gas-monitoring cell 208.

FIG. 4B depicts local distribution system 205B, which is a guided optics implementation of local distribution system 205 of FIG. 2. Local distribution system 205B includes optical circulator 430 and 1 x N fiber optical switch 434, both of which devices are well known to those skilled in the art.

Optical fiber 428 optically couples laser 202 to a first port of optical circulator 430. Optical fiber 432 couples a second port of optical circulator 430 to 1 x N fiber optical switch 434. And optical fiber 436 couples a third port of optical circulator 430 to detector 210.

Via the operation of optical circulator 430, beam 203 received at the first port is directed to the second port, through which beam 203 is launched into fiber 432 and received by 1 x N fiber optical switch 434. Beam 203 is directed into one fiber 207 at a time by switch 434 to interrogate a respective optically coupled gas-monitoring cell 208. A processor (i.e., part of “signal processing electronics 212”) controls the operation of fiber optical switch 434. Beam/signal 209 returning from a fiber 207 enters 1 x N switch 434 and is launched into fiber 432 to be received at the second port of optical circulator 430. Via the operation of the optical circulator, beam 209 is directed to the third port of the optical circulator, and launched into fiber 436 to be received at detector 210.

FIG. 5 depicts a portion of system 500 for detecting gas/gas leaks, including fiber relay system 506. The fiber relay system of gas/gas leak detection system 500 has a different architecture than fiber relay system 206 of system 200. Fiber relay system 506 includes a single optical fiber 207 leading from local distribution system 204 for delivering beam 203, and a plurality of optical switches 540, which are located along the fiber, for optically coupling to a respective gas-monitoring cell 208. In the example depicted in FIG. 5, there are four optical switches 540-1 through 540-4 that are optically coupled, via respective fibers 542-1 through 542-4, to respective gas-monitoring cells 208-1 through 208-4. In other embodiments, more optical switches and gas-monitoring cells may be present.

In FIG. 5, a gas of interest is present in gas-monitoring cell 208-3. The beam/signal 209 returned to detector 210 from this gas-monitoring cell will reveal, upon signal processing, the presence of gas. Knowing the location of gas-monitoring cell 208-3 in a monitored area, the location of a leak is therefore determined.

What is claimed is:

1. A system for identifying a presence and concentration of a gas in a monitored area, comprising:
a narrow-wavelength tunable laser for producing a beam of light, wherein the laser is tuned so that an optical frequency thereof is near to a frequency of an absorption line of a gas of interest, and is modulated to create a controlled scan across the frequency of the absorption line;
a plurality of gas-monitoring cells that are gas permeable, wherein the gas-monitoring cells are situated at various locations throughout the monitored area;
an optical delivery system comprising at least one optical fiber, wherein the optical delivery system guides the beam of light to each of the gas-monitoring cells, one gas-monitoring cell at a time, and wherein the beam of light is guided by the optical fiber for at least a portion of an optical path from the laser to each gas-monitoring cell;
a photodetector; and
signal-processing electronics; wherein:
(a) within each gas-monitoring cell, the beam of light received thereby propagates therethrough in free space, and then re-enters the optical delivery system and is directed thereby to the photodetector;
(b) the photodetector generates signals that are indicative, respectively, of an intensity of the beam of light delivered from each gas-monitoring cell; and
(c) the signal-processing electronics determines, for each gas-monitoring cell, if the gas of interest is present and, if so, a concentration thereof, based on the intensity of the respective beams of light.

2. The system of claim 1 wherein the laser is a distributed feedback laser.

3. The system of claim 1 wherein each gas-monitoring cell includes a collimation lens and a retroreflector that are spaced apart from one another.

4. The system of claim 1 wherein the optical delivery system includes at least one optical switch that is optically coupled to the at least one optical fiber.

5. The system of claim 1 wherein the optical delivery system includes a local distribution system and a fiber relay system, wherein the fiber relay system includes a plurality of optical fibers, including the at least one optical fiber, which are in optical communication with the gas-monitoring cells.

6. The system of claim 5 wherein the local delivery system consists of free-space optics that delivers the beam of light to the fiber relay system.

7. The system of claim 6 wherein the free-space optics portion includes a beam splitter, a beam steerer, and a collimation lens.

8. The system of claim 7 wherein the beam steerer is a galvanometer.

9. The system of claim 5 wherein each one of the optical fibers is directly optically coupled to respective ones of the gas-monitoring cells.

10. The system of claim 1 wherein a plurality of optical switches are coupled to the at least one optical fiber, and wherein each of the optical switches are optically coupled to respective ones of the gas-monitoring cells via respective ones of optical fibers.

11. The system of claim 5 wherein the local delivery system consists of guided optics that delivers the beam of light to the fiber relay system.

12. The system of claim 11 wherein the guided optics comprise an optical circulator and a 1 x n optical switch, wherein a first optical fiber optically couples the laser to the optical circulator, and a second optical fiber couples the optical circulator to the 1 x n optical switch.

13. The system of claim 12 wherein the plurality of optical fibers of the fiber relay system are optically coupled to the 1 x n optical switch.

14. The system of claim 1 wherein the gas of interest is methane.

15. A method for identifying the presence and concentration of a gas in a monitored area, the method comprising:
generating a first beam of light from a narrow-wavelength tunable laser, wherein the first beam of light:
(a) has an optical frequency near to a frequency of an absorption line of a gas of interest, and
(b) is modulated to create a controlled scan across the frequency of the absorption line;
receiving, at a local distribution system, the first beam of light, wherein the local distribution system directs the first beam of light to a fiber relay system comprising a plurality of optical fibers, wherein the optical fibers are optically coupled to a plurality of gas-monitoring cells that are situated at various locations throughout the monitored area;
receiving the first beam of light from the optical fibers at respective ones of the gas-monitoring cells, one gas-monitoring cell at a time;
directing the first beam of light through the respective ones of the gas-monitoring cells;
launching, one at a time, into the fiber relay system, respective beams of light resulting from passage of the first beam of light through the respective gas-monitoring cells;
receiving, at the local distribution system, the respective beams of light from the fiber relay system and directing the respective beams of light, one at a time, to a photodetector;
generating, at the photodetector, signals that are indicative of an intensity of the respective beams of light; and
determining, for each of the gas-monitoring cells, if the gas of interest is present and, if so, a concentration thereof, based on the signals.

16. The method of claim 15 wherein determining the concentration of the gas of interest comprises extracting a second harmonic of each signal generated by the photodetector.
